(19) United States
(12) Patent Application Publication
(10) Pub. No.: US 2008/0168498 A1
(43) Pub. Date: Jul. 10, 2008

(54) BROADCAST RECEIVING APPARATUS AND METHOD FOR FOCUS MANAGEMENT BY APPLICATION

(75) Inventor: Kwang-hyun Koh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/843,997

(22) Filed: Aug. 23, 2007

Related U.S. Application Data
(60) Provisional application No. 60/879,535, filed on Jan. 10, 2007.
(60) Provisional application No. 60/880,693, filed on Jan. 17, 2007.

(30) Foreign Application Priority Data
Mar. 21, 2007 (KR) 10-2007-27623

(51) Int. Cl. G06F 3/00

(52) U.S. Cl. 725/43

(57) ABSTRACT

A method for focus management by applications and a broadcast receiving apparatus incorporating the same are provided. One of a plurality of applications executable on the broadcast receiving apparatus determines one of the plurality of applications to take a focus, and notifies it to a middleware, which handles focus shift between the applications. As a result, a plurality of broadcast-related services are provided on a screen and one of the windows is activated.

### CROSS-REFERENCE TO RELATED APPLICATIONS

This application claims priority from U.S. Provisional Application Nos. 60/879,535 and 60/880,693 filed on Jan. 10, 2007 and Jan. 17, 2007, respectively, in the United States Patent and Trademark Office, and Korean Patent Application No. 10-2007-27623 filed on Mar. 21, 2007 in the Korean Intellectual Property Office, the entire disclosures of which are incorporated herein by reference.

### BACKGROUND OF THE INVENTION

1. Field of the Invention

Apparatuses and methods consistent with the present invention relate to broadcast reception, and more particularly, to providing users with received broadcast programs and services related with the broadcast.

2. Description of the Related Art

Data broadcast service has been launched with the advancement of digital and broadcast technologies. Therefore, television (TV) viewers are provided with not only broadcast programs, but also data broadcast service. A variety of different data broadcast services which can be provided through a TV screen are currently available.

The data broadcast service is visualized on a window which is displayed on a TV screen. A plurality of windows can sometimes appear on one TV screen, only one of which is activated. The viewer can access the activated window.

### SUMMARY OF THE INVENTION

The present invention provides a method and apparatus for managing focus shift among broadcast-related applications, according to which a key window is activated among a plurality of windows appearing on a screen to provide a plurality of broadcast-related services.

According to an aspect of the present invention, there is provided a method for focus management, including determining, by one of a plurality of applications executable on a broadcast receiving apparatus, one of the plurality of applications to take a focus, and notifying, by the one application determining the application to take the focus, a middleware handling a focus shift between the applications, of information about the determined application.

The method may further include that information about the determined application may include at least one of an identification (ID) of an organization related to the determined application, and an ID given to the determined application.

The method may further include shifting, by the middleware, the focus to the application identified by the information about the determined application.

The method may further include notifying, by the middleware, the one application determining which application to take the focus, that an application having had the focus returns the focus, and the determining may be performed by the one application determining which application to take the focus, if the middleware notifies the one application determining which application to take the focus, that the application having had the focus returns the focus.

The method may further include requesting, by the one application determining which application to take the focus, the middleware to notify it if the middleware detects that the application having had the focus returns the focus,detecting, by the middleware, whether the application having had the focus returns the focus, upon receipt of the request, and if the middleware detects that the application having had the focus returns the focus, the middleware may notify the application determining which application to take the focus that the application that had the focus returns the focus.

The method may further include notifying, by the middleware the one application determining which application to take the focus, of an input user command, and the determining including incorporating the user command in determining which application to take the focus.

The method may further include each application of the plurality of applications handling a broadcast-related service provided through the broadcast receiving apparatus, and the plurality of applications may also include the one application determining which application to take the focus.

The method may further include that at least one of the plurality of applications may be downloaded to the broadcast receiving apparatus via a communication medium.

The method may further include that the broadcast-related service may include at least one of a duplex data broadcast service, and a simplex data broadcast service.

The method may further include that the one application determining which application to take the focus may manage shift of the focus between the applications by the middleware, and handle a broadcast-related service provided through the broadcast receiving apparatus.

The method may further include that the one application determining which application to take the focus may be downloaded to the broadcast receiving apparatus via a communication medium.

According to another aspect of the present invention, there is provided a broadcast receiving apparatus, including a storage unit which stores a plurality of applications and a middleware which handles a focus shift between the applications, and a control unit which executes at least one of the plurality of applications stored in the storage unit, and the middleware. One of the plurality of applications may determine one of the plurality of applications to take a focus, and may notify the middleware of information about the determined application.

According to another aspect of the present invention, there is provided a broadcast receiving apparatus, including a storage unit which stores a plurality of applications and a middleware which handles a focus shift between the applications, and a control unit which executes one of the plurality of applications such that the one application determines one of the plurality of applications to take a focus, and that information about the determined application is notified to the middleware.

According to another aspect of the present invention, there is provided a broadcast receiving apparatus, including a storage unit which stores an application which determines one of a plurality of applications executable on the broadcast receiving apparatus to take a focus, and notifies a middleware, which handles focus shift between the applications, of information about the determined application, and a control unit which executes the applications stored in the storage unit.

According to another aspect of the present invention, there is provided a broadcast receiving apparatus, including a storage unit which stores a plurality of applications executable on the broadcast receiving apparatus, and a middleware which handles focus shift between the applications, and a control unit which executes one of the plurality of applications stored in the storage unit, such that the one application determines one of the plurality of applications to take a focus and notifies the middleware of information about the determined application.

According to another aspect of the present invention, there is provided a method for focus management, including receiving information about one of a plurality of applications executable on a broadcast receiving apparatus to take a focus, from one of the plurality of applications, and shifting the focus to the application identified by the received information regarding the application.

According to another aspect of the present invention, there is provided a broadcast receiving apparatus, including a storage unit which stores a middleware which receives information about one of a plurality of applications executable on the broadcast receiving apparatus to take a focus, and shifts the focus to the application identified by the received information regarding the application, and a control unit which executes the middleware stored in the storage unit.

According to another aspect of the present invention, there is provided a broadcast receiving apparatus, including a storage unit which stores a middleware, and a control unit which executes the middleware stored in the storage unit such that information regarding one of a plurality of applications executable on the broadcast receiving apparatus to take a focus is received from one of the plurality of applications, and the focus is shifted to the application identified by the received information regarding the application.

According to another aspect of the present invention, there is provided a computer-readable recording medium on which an application to perform a method for focus management is stored, the method for focus management including determining one of a plurality of applications executable on a broadcast receiving apparatus to take a focus, and notifying a middleware handling a focus shift between the applications, of information about the determined application.

According to another aspect of the present invention, there is provided a computer-readable recording medium on which a middleware which performs a method for focus management is stored, the method for focus management including receiving information about one of a plurality of applications executable on a broadcast receiving apparatus to take a focus, from one of the plurality of applications, and shifting the focus to the application identified by the received information about the application.

According to another aspect of the present invention, there is provided a method for focus management, including determining one of a plurality of applications executable on a broadcast receiving apparatus to take a focus, according to a selection by a user, and shifting a focus to the application selected by the user.

According to another aspect of the present invention, there is provided a method for focus management, including one of a plurality of applications executable on a broadcast receiving apparatus determining one of the plurality of applications to take a focus, based on information received from an external source, and the one application determining which application to take a focus, notifying a middleware, which handles focus shift between the applications, of the information regarding the determined application.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a block diagram illustrating a digital television (DTV) according to an exemplary embodiment of the present invention;

FIG. 2 is a view illustrating a method of focus management by applications according to an exemplary embodiment of the present invention;

FIG. 3 is a view illustrating a method for focus management by applications according to another exemplary embodiment of the present invention;

FIG. 4 is a block diagram illustrating a broadcast receiving apparatus according to an exemplary embodiment of the present invention;

FIG. 5 is a flowchart illustrating a method for focus management according to another exemplary embodiment of the present invention;

FIG. 6 is a block diagram illustrating a broadcast receiving apparatus according to yet another exemplary embodiment of the present invention;

FIG. 7 is a block diagram illustrating a broadcast receiving apparatus according to yet another exemplary embodiment of the present invention; and

FIG. 8 is a view illustrating a method for focus management according to yet another exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

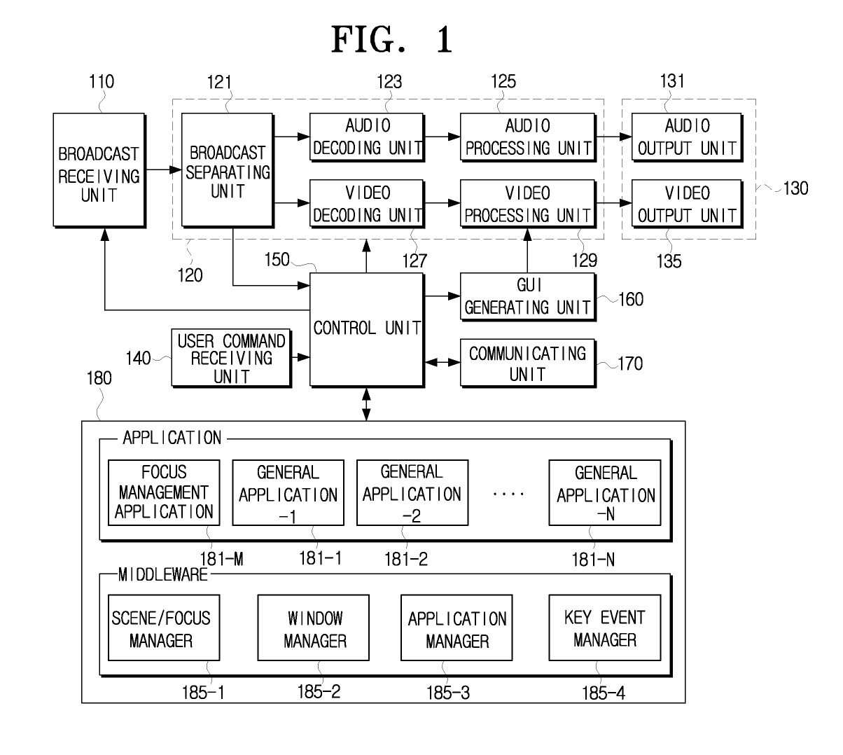

FIG. 1 is a block diagram illustrating a digital television (DTV) according to an exemplary embodiment of the present invention. According to an exemplary embodiment of the present invention, the DTV provides viewers with digital broadcast programs, and data broadcast service to be operated by the viewer. The data broadcast service may comprise simplex service and duplex service.

The DTV according to an exemplary embodiment of the present invention comprises a broadcast receiving unit 110, a broadcast processing unit 120, a broadcast output unit 130, a user command receiving unit 140, a control unit 150, a graphical user interface (GUI) generating unit 160, a communicating unit 170 and a storing unit 180.

The broadcast receiving unit 110 tunes to one of a plurality of broadcasts being received in a wired or wireless manner, and decodes the received signal.

The broadcast processing unit 120 processes the broadcast signal output from the broadcast receiving unit 110. The broadcast processing unit 120 includes a broadcast separating unit 121, an audio decoding unit 123, an audio processing unit 125, a video decoding unit 127 and a video processing unit 129.

The broadcast separating unit 121 separates the broadcast signal output from the broadcast receiving unit 110 into a video signal, an audio signal and supplemental data, and outputs the separated signals and data. The video and audio signals separated from the broadcast signal are supplied to the video decoding unit 127 and the audio decoding unit 123, respectively, which will be explained in greater detail below, and used for providing digital broadcast program.

The supplemental data being separated from the broadcast signal is supplied to the control unit 150 and used for providing data broadcast service. The supplemental data may include applications to be executed on the DTV to provide data broadcast service, or data regarding the information to be provided through the applications.

The audio decoding unit 123 decodes the audio signal output from the broadcast separating unit 121. Accordingly, a de-compressed audio signal is output from the audio decoding unit 123.

The audio processing unit 125 converts the decoded audio signal being output from the audio decoding unit 123 into a suitable format to be output through a speaker of the DTV.

The video decoding unit 127 decodes the video signal output from the broadcast separating unit 121. Accordingly, a de-compressed video signal is output from the video decoding unit 127.

The video processing unit 129 converts the decoded video signal output from the video decoding unit 127 into a suitable format to be output through a display of the DTV. The video processing unit 129 may perform processing of the decoded video signal, such as color signal processing, scaling, or the like.

The GUI generating unit 160 generates a GUI to be displayed on the display. The GUI generated at the GUI generating unit 160 is supplied to the video processing unit 129, and added to a video to be displayed on the display, in an On-Screen Display (OSD) operation.

The output unit 130 outputs a video and an audio corresponding respectively to the video signal and the audio signal output from the broadcast processing unit 120, to thus provide the user with the video and audio. To this end, the output unit 130 comprises an audio output unit 131 and a video output unit 135.

The audio output unit 131 outputs the audio signal from the audio processing unit 125 either through a speaker, or through an external display such as an external TV, which is connected through an external output terminal.

The video output unit 135 outputs the video signal from the video processing unit 129 either through a display, or through an external display such as an external TV, which is connected through an external output terminal.

The communicating unit 170 transmits a request or intention of a user to a broadcasting station through an external communication network, and provides a duplex data broadcast service.

The user command receiving unit 140 transmits a user command received through a remote control to the control unit 150, and the control unit 150 controls the overall operation of the DTV according to a user command provided from the user command receiving unit 140.

In other words, the control unit 150 controls the operation of the broadcast receiving unit 110 and the broadcast processing unit 120 so that digital broadcast program can be provided to a user. The control unit 150 also provides the user with data broadcast service, using the supplemental data provided by the broadcast separating unit 121.

The storage unit 180 stores programs which are used by the control unit 150 to execute data broadcast services. The storage unit 180 may include a memory, a Hard Disk Drive (HDD), or the like.

The storage unit 180 may store applications necessary for the data broadcast service, programs such as middleware, or the like, which will be explained in greater detail below.

The applications may include a focus management application 181-M and general applications 181-1 to 181-N. The applications may call for the other applications or middleware, or use the function of the applications or middleware, using Application Programming Interface (API).

The general applications 181-1 to 181-N are applications necessary for the provision of data broadcast service. In other words, the control unit 150 must execute the general applications 181-1 to 181-N in order to provide data broadcast service.

Each of the general applications 181-1 to 181-N handleS different data broadcast services. For example, a first general application 181-1 may be required for providing a user, through a display, with weather information included in the supplemental data of the broadcast signal, a second general application 181-2 for providing t-commerce service such as home shopping, . . . , and an Nth general application 181-N for providing a user, through a display, with traffic information of the supplemental data of the broadcast signal.

If the first general application 181-1 alone is executed according to the control of the control unit 150, the user is provided with the weather information service only. If the first and second general applications 181-1 and 181-2 are executed, the user is provided with both the weather information and t-commerce service.

The general applications 181-1 to 181-N may be downloaded from a broadcast station and stored in the storage unit 180. More specifically, the general applications 181-1 to 181-N may be received at the broadcast receiving unit 110 in the form of supplemental data carried in the broadcast signal, separated at the broadcast separating unit 121, supplied to the control unit 150, stored at the storage unit 180 and activated according to the control unit 150.

The focus management application 181-M also is an application which is required for providing data broadcast service, as other general applications 181-1 to 181-N.

For example, the focus management application 181-M may be used for providing a user with stock information in the supplemental data of the broadcast signal, through a display. In other words, the control unit 150 may execute the focus management application 181-M to provide the user with stock information service.

Like other general applications 181-1 to 181-N, the focus management application 181-M may be downloaded from a broadcast station and stored at the storage unit 180. The focus management application 181-M may call for the other applications or middleware, or use the function of the other applications or middleware, using the API, as other applications do.

While a plurality of applications among the applications 181-M, 181-1 to 181-N are activated according to the control unit 150, only one of the activated applications takes the focus.

The focus management application 181-M is distinguished from the other general applications 181-1 to 181-N in the fact that the focus management application 181-M manages the focus.

In other words, the focus management application 181-M manages the focus such that one of the applications 181-M, 181-1 to 181-N takes the focus, which will be explained below in greater detail.

The storage unit 180 stores not only the applications 181-M, 181-1 to 181-N, but also middleware. The middleware may include scene/focus manger 185-1, window manager 185-2, application manager 185-3 and key event manager 185-4. The middleware may be stored in the storage unit 180 of the DTV at the factory before the DTV is shipped.

The scene/focus manager 185-1 is the middleware that designates a scene for the application. The scene may be a window area which is displayed for the activated application to provide data broadcast service. In other words, the scene/focus manager 185-1 designates an area on the display at which a window, generated according to the activation of the application, is displayed.

The scene/focus manager 185-1 also handles focus shift between applications. For example, the scene/focus manager 1851 may cause the focus of the first application 181-1 to shift to the second application 181-2 so that the second application 181-2 can take the focus.

If ‘an application takes the focus,’ it means that i) a window for the application is activated on a display, and that ii) if the window of the application provides the selectable items, that a cursor is pointing at one of the selectable items, or one of the selectable items is in highlight.

To ‘shift the focus from the first application 181-1 to the second application 181-2’ indicates that i) the window of the first application 181-1 is inactivated, ii) that the window of the second application 181-2 is activated, and iii) if the window of the second application 181-2 provides the selectable items, that a cursor is pointing at one of the selectable items, or one of the selectable items is in highlight.

The scene/focus manager 185-1 follows the management of the focus management application 181-M, in handling the shift of the focus between the applications.

The window manager 185-2 is a middleware which generates a window to be displayed on a scene designated by the scene/focus manager 185-1. The window manager 185-2 involves the GUI generating unit 160. In other words, the window manager 185-2 is the middleware which generates a GUI type window which is supplied by the GUI generating unit 160 to the video processing unit 129.

While a window is generated, the window manager 185-2 takes into consideration the result of focus shift by the scene/focus manager 185-1. Specifically, the window manager 185-2 operates to i) generate a window in an inactive state for an application which currently does not have the focus, and ii) generate a window in an active state for an application which currently has the focus. If the window of the application provides the selectable items, the window manager 185-2 generates a cursor or highlight at one of the selectable items.

The application manager 185-3 writes an Application Information Table (AIT), which lists information about the currently-activated applications. The AIT may include application information such as organization IDs of the applications, application IDs, or the like.

The organization ID involves an organization related with the application. The organization may have made, or distributed the application. The application ID is given to the application by the organization.

The key event manager 185-4 is a middleware which, when in receipt of a user command received from the user command receiving unit 140, recognizes the received user command and transmits the recognized user command to a corresponding application.

While a plurality of applications are activated at the same time, the focus shifts between the applications according to the management of the focus management application 181-M by the following processes which will be explained in detail below.

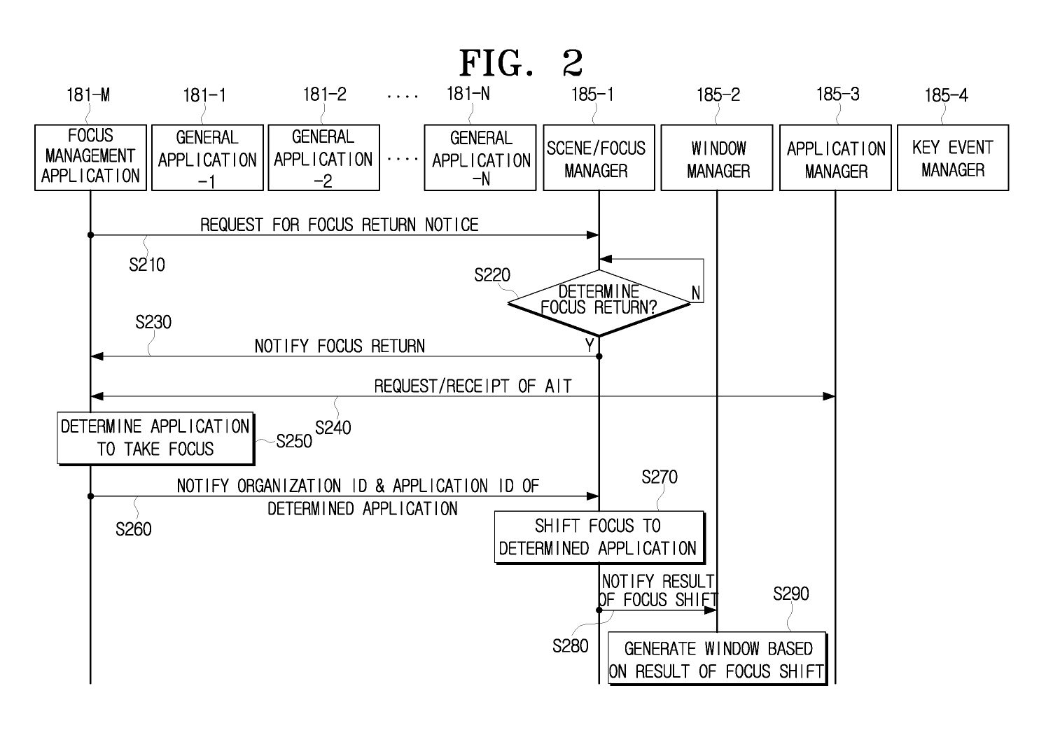

First, the process at an application giving back the focus, in particular, the process in which the focus is shifted between the applications according to the management of the focus management application 181-M, will be explained below with reference to FIG. 2.

In an exemplary embodiment of the present invention, the focus management application 181-M requests the scene/focus manager 185-1 for a ‘indication of focus return’ (S210). The ‘indication of focus return’ refers to the notification of the scene/focus manager 185-1, informing that it is detected that a certain application gives back the focus.

An application gives the focus back, upon terminating or inactivating.

The scene/focus manager 185-1 determines whether or not an application gives back the focus (S220). Upon determining that the focus is returned (S220-Y), the scene/focus manager 185-1 notifies it to the focus management application 181-M (S230).

The focus management application 181-M then requests the third application manager 185-3 for AIT and receives the AIT (S240). The focus management application 181-M determines one of the applications listed in the received AIT to take the returned focus (S250).

In determining the application to take the focus in operation S250, the focus management application 181-M may determine the application listed in the AIT having the highest priority to take the focus.

The focus management application 181-M notifies the scene/focus manager 185-1 of the organization ID and the application ID of the selected application (S260).

The scene/focus manager 185-1 then shifts the focus to the application which is indicated by the notified organization ID and the application ID (S270). In other words, in operation S270, the scene/focus manager 185-1 shifts the focus to the application selected in operation S250.

The scene/focus manager 185-1 notifies the window manager 185-2 of the result of focus shift (S280). The window manager 185-2 incorporates the result of focus shift, such that the windows are generated regarding the activated applications (S290). As a result, focus is shifted.

Although an application to which the focus is shifted is determined according to the priority of the data broadcast services in the exemplary embodiment explained above, an application to take the focus may be determined in other manners.

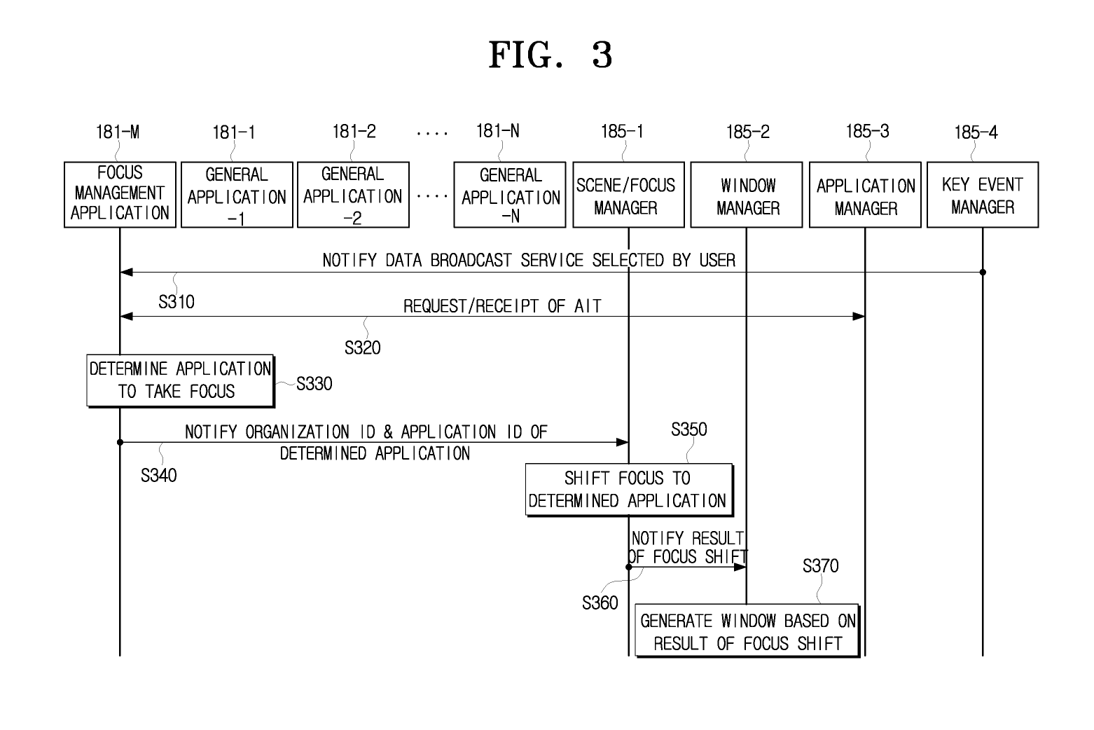

The process in which a user requests a data broadcast service, and the focus is shifted between the applications according to the management of the focus management application 181-M, will be explained below, with reference to FIG. 3.

In an exemplary embodiment of the present invention, the key event manager 185-4 provides the focus management application 181-m with information about the selected data broadcast service (S310). The data broadcast service is selected by the user, by inputting a key on a GUI or a remote controller.

The focus management application 181-M requests the application manager 185-3 for AIT and receives the AIT (S320).

The focus management application 181-M determines one of the applications listed in the received AIT to take the focus, if the determined application handles the data broadcast service informed at operation S310 (S330). In other words, at operation S330, the focus management application 181-M determines an application to take the focus, based on user selection.

The focus management application 181-M notifies the scene/focus manager 185-1 of the organization ID and the application ID of the selected application (S340). The scene/focus manager 185-1 shifts the focus to the application identified by the notified organization ID and the application ID (S350).

The scene/focus manager 185-1 notifies the result of focus shift to the window manager 185-2 (S360). The window manager 185-2 incorporates the notified result of focus shift, in generating windows regarding the executed applications (S370). Accordingly, focus is shifted.

Although the above particular exemplary embodiment of the present invention explains that the user requests a data broadcast service, user commands may vary. For example, a user may request a certain application to be executed, in which case the focus is shifted between the applications under the management of the focus management application 181-M.

The above exemplary embodiments explained the process of shifting a focus between applications under the management of the focus management application 181-M, according to returning of a focus by an application, and according to a request by a user for data broadcast service.

One will understand that the present invention is not limited to the above exemplary embodiments. A focus may be shifted between applications under the management of the focus management application 181-M, if it is internally determined that a focus shift is necessary to provide a user with a new data broadcast service in an urgent basis, or prior to the other services.

The above exemplary embodiments described that the focus management application 181-M requests the application manager 185-3 for AIT and receives AIT, but other embodiments are possible. For example, the focus management application 181-M may have AIT in advance, or may receive AIT through the scene/focus manager 185-1.

Other exemplary embodiments, in which the focus management application returns the focus, or an application handling a data broadcast service as requested by the user operates as the focus management application 181-M, may be also applicable. The application to take the focus may be the focus management application 181-M. In other words, the focus management application 181-M may determine itself as the next application to take the focus.

Although the above exemplary embodiments employed the applications handling data broadcast services as an example, another example with the applications handling other types of broadcast services are also applicable to the inventive concept of the present invention.

Although the above exemplary embodiments described that the applications to be downloaded are contained in the supplementary data carried by the wired, or wireless broadcast signal, the applications may be downloaded through other types of communication media. For example, the applications may be downloaded through an input terminal provided at a DTV. Alternatively, the applications may be stored at the factory before the DTVs are shipped.

Updated middleware may be downloaded from a broadcast station to the storage unit 180, or received through an input terminal of a DTV and then downloaded to the storage unit 180.

The focus management application 181-M may perform focus management during the data broadcast service. Of course, the focus management application 181-M may perform the focus management when the data broadcast service is not provided to the user. In other words, the focus management application 181-M performs focus management regardless of whether the window of the focus management application 181-M is displayed or not.

The above exemplary embodiments described the focus management application 181-M to handle both a data broadcast service and focus management. However, one will understand that the focus management application 181-M may be configured to handling focus management only, as occasion demands.

The above exemplary embodiments explained that the focus management application 181-M notifies the scene/focus manager 185-1 of the organization ID and the application ID of a selected application. However, this is only for the exemplary purpose, and other types of information may be provided. For example, information of the application may include information about the scene designated in the application, information about the title of the application, or the like. AIT will have to list this information too, if they are used.

The above exemplary embodiments described that one of the currently executed applications is selected to take a focus, but one will understand that this is only for convenience of explanation. Therefore, one will understand that even an application, which is currently not executed, may also be selected to take a focus. In this case, AIT lists information about all the applications stored in the storage unit 180, that is, lists information about the applications currently executed and the applications currently not executed.

The above exemplary embodiments employed a DTV as a broadcast receiving apparatus which incorporates a focus management method according to the general inventive concept of the present invention. However, one will understand other types of broadcast receiving apparatuses, such as settop box, or DMB player, are also applicable.

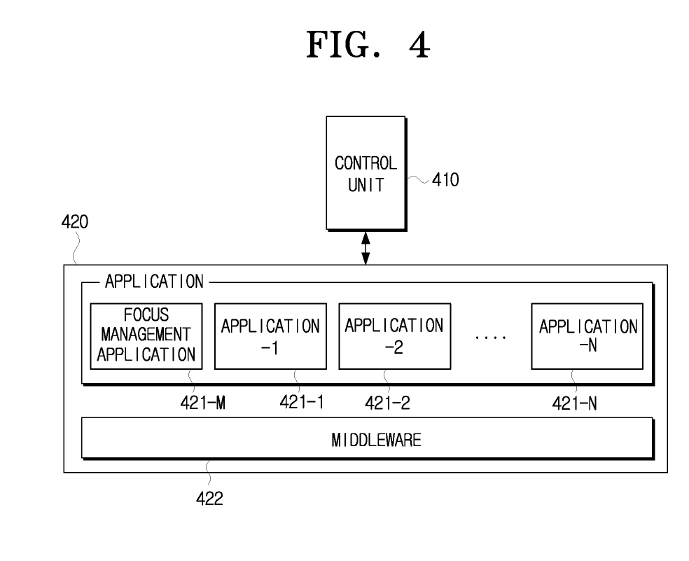

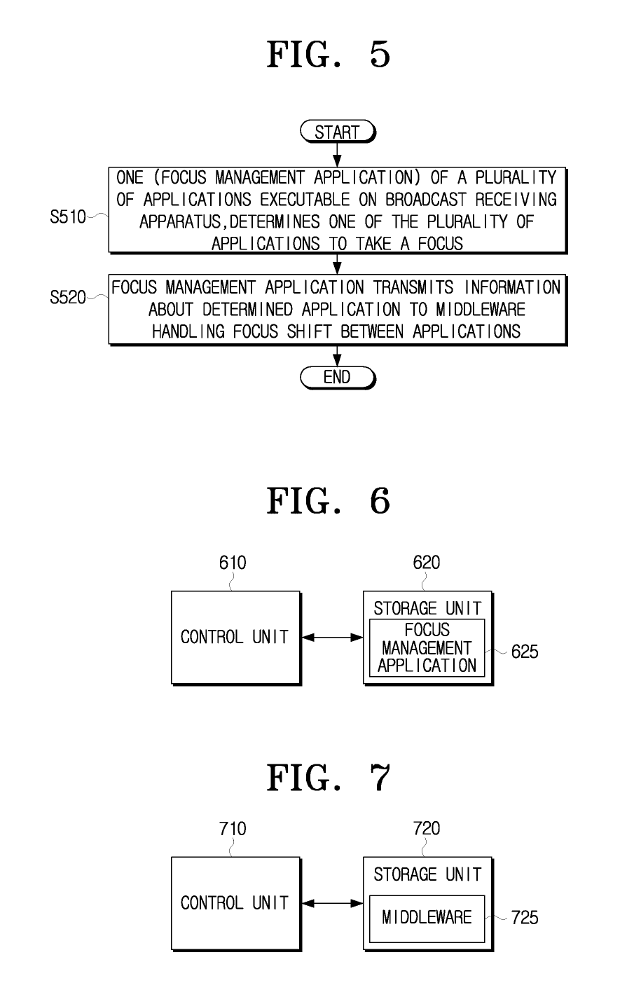

Another exemplary embodiment of the preset invention will be explained below, with reference to FIGS. 4 and 5. A broadcast receiving apparatus according to another exemplary embodiment of the present invention includes a control unit 410 and a storage unit 420.

The storage unit 420 stores a plurality of applications 421-M, 421-1 through 421-N, and a middleware 422 which handles focus shift between the applications. One of the plurality of applications is a focus management application 421-M.

The focus management application 421-M determines one of the plurality of applications 421-M, 421-1 through 421-N to take a focus, and notifies the middleware 422 with the information about the determined application.

The control unit 410 executes at least one of the plurality of applications 421-M, 421-1 through 421-N stored in the storage unit 420 and the middleware 422, such that one of the applications 421-M, 421-1 through 421-N is determined to take a focus by the focus management application 421-M. The information about the determined application is notified to the middleware 422.

According to the method of managing focus illustrated in FIG. 5, one of the plurality of applications 421-M, 421-1 through 421-N executable on the broadcast receiving apparatus, such as, the focus management application 421-M, determines one of the plurality of applications 421-M, 421-1 through 421-N to take a focus (S510).

The focus management application 421-M notifies the middleware 422 handling focus shift between the applications, of the information about the determined application (S520).

Yet another exemplary embodiment of the present invention will be explained below, with reference to FIG. 6. A broadcast receiving apparatus according to yet another exemplary embodiment of the present invention may comprise a control unit 610 and a storage unit 620.

The storage unit 620 stores a focus management application 625. The focus management application 625 determines one of a plurality of executable applications of the broadcast receiving apparatus to take a focus, and notifies a middleware which handles focus shift between the applications with the information about the determined application.

The control unit 610 executes the focus management application 625 stored in the storage unit 610, such that one of the plurality of applications is determined to take a focus according to the focus management application 625, and the information about the determined application is notified to the middleware.

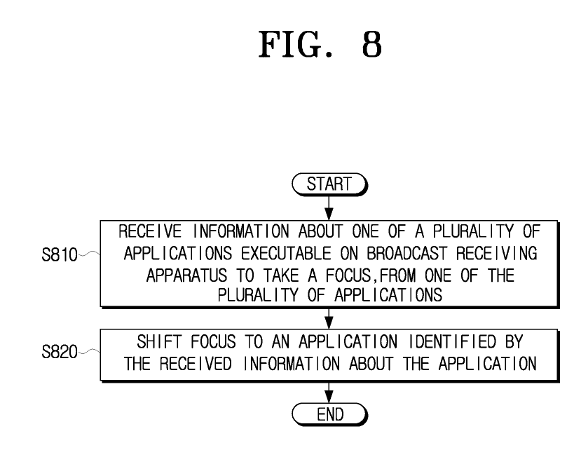

Yet another exemplary embodiment of the present invention will be explained below, with reference to FIGS. 7 and 8. A broadcast receiving apparatus according to yet another exemplary embodiment of the present invention includes a control unit 710 and a storage unit 720.

The storage unit 720 stores a middleware 725. The middleware 725 receives information about one of a plurality of executable applications on the broadcast receiving apparatus that is determined to take a focus, and shifts the focus to the applications identified by the received information.

The control unit 710 executes the middleware 725 stored in the storage unit 720 such that the middleware 720 receives information about one of the plurality of executable applications of the broadcast receiving apparatus that is determined to take a focus, and shifts the focus to the application identified by the received information.

According to the method of managing focus illustrated in FIG. 8, first, the middleware 725 receives, from one of a plurality of executable applications on the broadcast receiving apparatus, information regarding an application among the plurality of executable applications to take a focus (S810).

The middleware 725 shifts the focus to the application identified by the information received (S820).

As a result, focus is shifted between the applications by the management of the focus management application.

The above exemplary embodiments of the present invention described that a focus management application manages a focus. However, other applications or middleware may manage the focus, and a focus may be shifted to an application according to a selection by the user.

A user is not required to determine an application to take a focus. In other words, a broadcast station, or a service provider may determine an application to take a focus. In this case, the focus management application determines an application to take a focus based on external information (information regarding an application to take a focus) which is received from, for example, a broadcast station or a service provider. The information about the determined application is then notified to the middleware.

As explained above, according to the exemplary embodiments of the present invention, the focus shift between the applications handling broadcast-related service, may be managed by an application, or other types of programs. As a result, a more efficient process is provided, in which a plurality of broadcast-related services are provided on a screen and one of the windows is activated.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method for focus management the method comprising:
determining, by one of a plurality of applications executable on a broadcast receiving apparatus, one of the plurality of applications to take a focus; and
notifying, by the one application determining the application to take the focus, a middleware handling a focus shift between the applications, of information about the determined application.

2. The method of claim 1, wherein the information about the determined application comprises at least one of an identification of an organization related to the determined application, and an identification given to the determined application.

3. The method of claim 1, further comprising shifting, by the middleware, the focus to the application identified by the information about the determined application.

4. The method of claim 1, further comprising notifying, by the middleware, the one application determining which application to take the focus, that an application having had the focus returns the focus, and
wherein the determining is performed by the one application determining which application to take the focus, if the middleware notifies the one application determining the application to take the focus that the application having had the focus returns the focus.

5. The method of claim 4, further comprising:
requesting, by the one application determining the application to take the focus, the middleware to notify it if the middleware detects that the application having had the focus returns the focus; and
detecting, by the middleware, whether the application having had the focus returns the focus, upon receipt of the request, and
wherein, if the middleware detects that the application having had the focus returns the focus, the middleware notifies the one application determining which application to take the focus that the application that had the focus returns the focus.

6. The method of claim 1, further comprising notifying, by the middleware, the one application determining which application to take the focus, of an input user command,
wherein, the determining further comprises incorporating the user command in determining which application to take the focus.

7. The method of claim 1, wherein each application of the plurality of applications handles a broadcast-related service provided through the broadcast receiving apparatus, and the plurality of applications comprise the one application determining which application to take the focus.

8. The method of claim 7, wherein at least one of the plurality of applications is downloaded to the broadcast receiving apparatus via a communication medium.

9. The method of claim 7, wherein the broadcast-related service comprises at least one of a duplex data broadcast service and a simplex data broadcast service.

10. The method of claim 1, wherein the one application determining which application to take the focus manages shift of the focus between the applications by the middleware, and handles a broadcast-related service provided through the broadcast receiving apparatus.

11. The method of claim 10, wherein the one application determining which application to take the focus is downloaded to the broadcast receiving apparatus via a communication medium.

12. A broadcast receiving apparatus comprising:
a storage unit which stores a plurality of applications and a middleware which handles a focus shift between the applications; and
a control unit which executes at least one of the plurality of applications stored in the storage unit, and the middleware, wherein
one of the plurality of applications determines one of the plurality of applications to take a focus, and notifies the middleware of information about the determined application.

13. A broadcast receiving apparatus comprising:
a storage unit which stores a plurality of applications and a middleware which handles focus shift between the applications; and
a control unit which executes one of the plurality of applications such that the one application determines one of the plurality of applications to take a focus, and that information about the determined application is notified to the middleware.

14. A broadcast receiving apparatus comprising:
a storage unit which stores an application which determines one of a plurality of applications executable on the broadcast receiving apparatus to take a focus, and notifies a middleware, which handles focus shift between the applications, of information about the determined application; and
a control unit which executes the applications stored in the storage unit.

15. A broadcast receiving apparatus comprising:
a storage unit which stores a plurality of applications executable on the broadcast receiving apparatus, and a middleware which handles focus shift between the applications; and
a control unit which executes one of the plurality of applications stored in the storage unit, such that the one application determines one of the plurality of applications to take a focus and notifies the middleware of information about the determined application.

16. A method for focus management, the method comprising:
receiving information about one of a plurality of applications executable on a broadcast receiving apparatus to take a focus, from one of the plurality of applications; and
shifting the focus to the application identified by the received information regarding the application.

17. A broadcast receiving apparatus comprising:
a storage unit which stores a middleware which receives information about one of a plurality of applications executable on the broadcast receiving apparatus to take a focus, and shifts the focus to the application identified by the received information regarding the application; and
a control unit which executes the middleware stored in the storage unit.

18. A broadcast receiving apparatus comprising:
a storage unit which stores a middleware; and
a control unit which executes the middleware stored in the storage unit such that information regarding one of a plurality of applications executable on the broadcast receiving apparatus to take a focus is received from one of the plurality of applications, and the focus is shifted to the application identified by the received information regarding the application.

19. A computer-readable recording medium on which an application to perform a method for focus management is stored, the method for focus management comprising:
determining one of a plurality of applications executable on a broadcast receiving apparatus to take a focus; and
notifying a middleware handling a focus shift between the applications, of information about the determined application.

20. A computer-readable recording medium on which a middleware which performs a method for focus management is stored, the method for focus management comprising:
receiving information about one of a plurality of applications executable on a broadcast receiving apparatus to take a focus, from one of the plurality of applications; and
shifting the focus to the application identified by the received information about the application.

21. A method for focus management comprising:
determining one of a plurality of applications executable on a broadcast receiving apparatus to take a focus, according to a selection by a user; and
shifting a focus to the application selected by the user.

22. A method for focus management comprising:
one of a plurality of applications executable on a broadcast receiving apparatus, determining one of the plurality of applications to take a focus, based on information received from an external source; and
the one application determining one of the plurality of applications to take the focus, notifying a middleware, which handles focus shift between the applications, of the information regarding the determined application.
